(19) United States
(12) Patent Application Publication
(10) Pub. No.: US 2007/0149659 A1
(43) Pub. Date: Jun. 28, 2007

(54) Flame-retardant methacrylic composition

(76) Inventors: Jose Teixeira Pires, Neuilly-Sur-Seine (FR); Pierre-Louis Lambert, Lescar (FR); Patrick Delprat, Lescar (FR)

Correspondence Address: Thomas F. Roland, Esq.;Arkema Inc., 2000 Market St., Philadelphia, PA, 19103, US

(21) Appl. No.: 11/583,291

(22) Filed: Oct. 19, 2006

Related U.S. Application Data
(60) Provisional application No. 60/742,757, filed on Dec. 6, 2005.

(30) Foreign Application Priority Data
Oct. 20, 2005 (FR) 05.10700

(51) Int. Cl. C08K 5/49

(52) U.S. Cl. 524/115

(57) ABSTRACT

The invention relates to a flame-retardant methacrylic composition based on a methacrylic polymer comprising, per 100 parts of methacrylic polymer, from 15 to 25 parts, advantageously from 17 to 25 parts, preferably from 17 to 23 parts, more preferentially still from 19 to 22 parts, of at least one flame-retardant agent of formula (I) or (II): 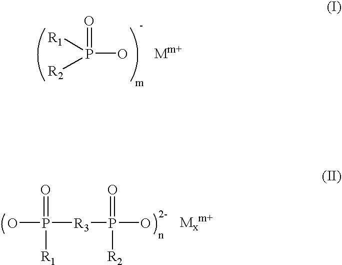 in which:
R₁ and R₂ denote linear or branched C₁-C₆ alkyl groups and/or aryl groups;
R₃ denotes a linear or branched C₁-C₁₀ alkylene group, a C₆-C₁₀ arylene group, an alkylarylene group or an arylalkylene group; M denotes Mg, Ca, Al, Sb, Sn, Ge, Ti, Zn, Fe, Zr, Ce, Bi, Sr, Mn, Li, Na or K; m is an integer between 1 and 4; n is an integer between 1 and 4; x is an integer between 1 and 4.

This application claims benefit, under U.S.C. §119 or §365 of French Application Number 05.10700, filed Oct. 20, 2005; and US 60/742,757 filed Dec. 6, 2005.

### FIELD OF THE INVENTION

The present invention relates to a flame-retardant methacrylic composition. This composition can be used for the manufacture of domestic electrical appliances (such as casings for televisions, covers for electrical or electronic appliances, and the like) or else of components which are used in the building industry (for example profiles). It can also be used to produce a flame-retardant coating, in particular by a coextrusion process. The invention also relates to the process for the conversion of the composition in order to obtain a multilayer structure comprising a layer of the composition and a layer of a thermoplastic polymer, and to the multilayer structure in itself.

### BACKGROUND OF THE INVENTION

Legislation increasingly requires that materials, in particular those used in the electrical or electronic field or in the building industry, should be rendered flame-retardant in order to minimize the spread of fires. Environmental constraints also require that flame-retardant formulations should not comprise halogen (halogen-free formulations) as, during the burning of halogenated flame-retardant agents, acidic and toxic gases are liable to be released.

The addition of one or more flame-retardant agent(s) must not result in a detrimental change in the properties of the methacrylic polymer, such as, for example, the melt flow or the thermo mechanical strength (Vicat).

The Applicant Company has found that it is possible to obtain a flame-retardant methacrylic composition categorized as V1 at 3 mm according to the UL-94 test while retaining good mechanical properties, in particular its Vicat temperature, and good melt flow. This composition can coat a thermoplastic polymer.

Application US 2005/0143503 discloses a flame-retardant agent in the form of agglomerated particles. The particles are composed of 99.99 to 80% of a (di)phosphinate and of 0.01 to 20% of a polymeric binder which can be based on acrylates.

International Application WO 2005/061606 discloses the flame-retarding of a thermoplastic polymer by a mixture of a compound (F1) similar to the compound (I) which is used in the present invention, of a compound (F2) which is a product of the reaction between phosphoric acid and melamine and/or a product of the reaction between phosphoric acid and a melamine condensation derivative and of a compound (F3) which is a melamine condensation derivative.

U.S. Pat. No. 6,420,459 or International Application US20050234173 disclose the flame-retarding of a thermoset polymer using a flame-retardant agent of formula (I) or (II).

Application US20050173684 discloses a flame-retardant combination composed of a (di)phosphinate and of a nitrogenous component of melamine type. The combination can be used in several types of thermoplastic polymers, in particular polymethacrylate. The content of each of the two flame-retardant agents can vary by weight from 1 to 30%, preferably from 3 to 20%, more preferentially still from 3 to 15%, with respect to the thermoplastic polymer. No example relates to a methacrylic polymer.

Patents DE 2447727 and DE 2252258 respectively disclose polyamides or polyesters rendered flame-retardant using (di)phosphinates.

U.S. Pat. No. 6,255,371 B1 discloses the use of (di)phosphinates as flame-retardant agents for thermoplastic polymers. The thermoplastic polymer can be in particular a polymethacrylate. The content of flame-retardant agent is, by weight, between 1 and 30%, preferably between 3 and 20%, more preferentially still between 3 and 15%, with respect to the thermoplastic polymer. No example relates to a methacrylic polymer.

Application U.S. Pat. No. 6,696,513 discloses a multilayer structure comprising a layer of a methacrylic composition rendered flame-retardant using a halogenated compound and a layer of a thermoplastic polymer, such as PVC.

In none of these documents is it suggested that the incorporation of 15 to 25 parts of a flame-retardant agent of formula (I) or (II) in 100 parts of a methacrylic polymer makes it possible to obtain a halogen-free flame-retardant composition which is V1 at 3 mm and which retains the good mechanical properties of the methacrylic polymer.

### SUMMARY OF THE INVENTION

The methacrylic polymer is a methyl methacrylate (MMA) homo- or copolymer comprising, by weight, at least 70%, advantageously 80%, of MMA. Preferably, it is a copolymer of MMA and of at least one comonomer having at least one ethylenic unsaturation which can be copolymerized with the MMA.

The comonomer is chosen from the list of the:
acrylic monomers of formula CH₂═CH—C(═O)—O—R₁, where R₁ denotes a hydrogen atom or a linear, cyclic or branched C₁-C₄₀ alkyl group optionally substituted by a halogen atom or a hydroxyl, alcoxy, cyano, amino or epoxy group, such as, for example, acrylic acid, methyl, ethyl, propyl, n-butyl, isobutyl, tert-butyl, 2-ethylhexyl or glycidyl acrylate, hydroxyalkyl acrylates or acrylonitrile;
methacrylic monomers of formula CH₂═C(CH₃)—C(═O)—O—R₂ where R₂ denotes a hydrogen atom or a linear, cyclic or branched C₂-C₄₀ alkyl group optionally substituted by a halogen atom or a hydroxyl, alcoxy, cyano, amino or epoxy group, such as, for example, methacrylic acid, methyl, ethyl, propyl, n-butyl, isobutyl, tert-butyl, 2-ethylhexyl or glycidyl methacrylate, hydroxyalkyl methacrylates or methacrylonitrile;
vinylaromatic monomers, such as, for example, styrene, substituted styrenes, α-methylstyrene, monochlorostyrene or tert-butylstyrene.

The copolymer comprises, by weight, from 70 to 99.5%, advantageously from 80 to 99.5%, preferably from 80 to 98%, of MMA for respectively from 0.5 to 30%, advantageously from 0.5 to 20%, preferably from 2 to 20%, of at least one comonomer. Preferably, the methacrylic polymer has a melt flow index of from 0.5 to 30, preferably between 0.5 and 20, g/10 min (230° C., 3.8 kg) according to ISO 1133.

The methacrylic polymer can be impact-strengthened using an impact modifier, for example multilayer particles of core-shell type. The additive Durastrength® D320 sold by Arkema can be used, for example. These particles can, for example, be of the soft-hard or hard-soft-hard type.

As regards the thermoplastic polymer which is coated by the flame-retardant methacrylic composition, this can be, for example, a saturated polyester (PET, PETg, PBT, and the like), ABS, SAN (styrene/acrylonitrile copolymer), ASA (acrylic/styrene/acrylonitrile copolymer), a polystyrene (crystal or high-impact), a polypropylene (PP), a polyethylene (PE), polycarbonate (PC), PPO, a polysulphone, PVC, chlorinated PVC (CPVC) or expanded PVC.

It can also be a blend of two or more thermoplastic polymers from the above list. For example, it can be a PPO/PS or PC/ABS blend.

As regards the flame-retardant agent, the latter is chosen from the compounds of formula (I) or (II): 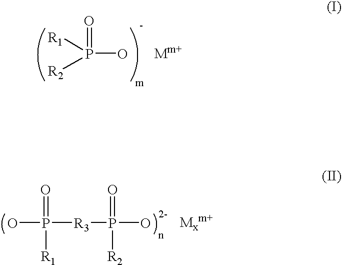
in which:
R₁ and R₂ denote linear or branched C₁-C₆ alkyl groups and/or aryl groups;

R₃ denotes a linear or branched C₁-C₁₀ alkylene group, a C₆-C₁₀ arylene group, an alkylarylene group or an arylalkylene group;
M denotes Mg, Ca, Al, Sb, Sn, Ge, Ti, Zn, Fe, Zr, Ce, Bi, Sr, Mn, Li, Na or K;
m is an integer between 1 and 4;
n is an integer between 1 and 4;
x is an integer between 1 and 4.

Two or more flame-retardant agents of formula (I) or (II) can also be combined. Advantageously, M denotes Ca, Al or Zn. Preferably, M denotes Al.

R₁ and R₂ are preferably alkyl groups, such as, for example, methyl, ethyl, n-propyl, isobutyl, n-butyl, tert-butyl or n-pentyl groups, and/or phenyl groups.

R₃ is preferably the methylene, ethylene, n-propylene, isopropylene, n-butylene, tert-butylene, n-pentylene, n-octylene or n-dodecylene group. They can also be the phenylene, methylphenylene, ethylphenylene, tert-butylphenylene, methylnaphthylene, phenylethylene, phenylpropylene or naphthylene group.

Preferably, use is made of a flame-retardant agent of formula (I) in which M denotes Al and R₁ and R₂ both denote a C₁-C₆ alkyl group. Preferably, R₁ and R₂ are both ethyl groups or else an ethyl group and a methyl group, that is to say that the flame-retardant agent corresponds to a product of formula (III) or (IV):

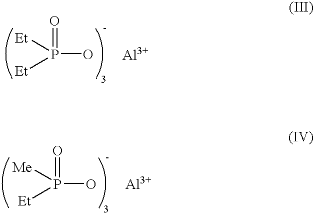

Preferably, so as to obtain good dispersion in the methacrylic polymer, the flame-retardant agent is provided in the form of particles having a mean diameter D50 (Microtrac) of between 0.5 and 10 μm, advantageously between 1 and 5 μm. The effectiveness of the flame-retardant agent may be optimum if the flame-retardant agent is homogeneously dispersed.

The flame-retardant agent can be used alone or else in combination with at least one other flame-retardant compound which makes it possible to reinforce the effectiveness of the flame-retardant agent. The methacrylic composition can thus optionally comprise at least one other flame-retardant compound chosen, for example, from the following list:
phosphorus compounds, such as organic phosphates;
silicon compounds, such as, for example, silicates, zeolites, silicas or siloxanes;
magnesium compounds, such as, for example, magnesium hydroxide, magnesium carbonate, magnesium oxide, hydrotalcite, dihydrotalcite, and the like;
calcium compounds, such as, for example, calcium hydroxide, calcium oxide, calcium carbonate, and the like;
zinc compounds, such as, for example, zinc oxide, zinc hydroxide, zinc oxide hydrate, and the like;
aluminium compounds, such as, for example, aluminium oxide, aluminium hydroxide, aluminium phosphate, and the like;
titanium compounds, such as titanium oxides, and the like;
antimony compounds, such as, for example, antimony trioxide, antimony tetroxide, antimony tartrate, and the like.

The other flame-retardant compound can also be a polymer not comprising halogen which would have better flame-retardant properties than the methacrylic polymer, for example polycarbonate. The other compound is not a product of the reaction between phosphoric acid and melamine and/or a product of the reaction between phosphoric acid and a melamine condensation derivative, nor a melamine condensation derivative, nor a halogenated compound, in particular a brominated compound.

As regards the flame-retardant methacrylic composition, the Applicant Company has found that it is possible for the methacrylic composition to be V1 according to the UL-94 test in the presence of a minimum proportion of flame-retardant agent (below, the composition is not V1). However, it is advisable not to exceed a maximum proportion of flame-retardant agent if the mechanical properties of the composition are not to deteriorate and if it is not to be rendered difficult to convert. The compounding of the flame-retardant agent and of the methacrylic polymer also becomes more difficult.

Thus, the proportion of flame-retardant agent must be, by weight, between 15 and 25 parts, advantageously between 17 and 25 parts, preferably between 17 and 23 parts, more preferentially still between 19 and 22 parts, per 100 parts of methacrylic polymer. In the proportions envisaged, the flame-retardant agent makes it possible to obtain very good flame retardancy while retaining the other characteristics, which are, for example, the melt flow and the thermomechanical strength. Surprisingly, these two properties are not significantly modified after the compounding, whereas, with numerous halogen-free flame-retardant agents, such as phosphate esters, for example, the Vicat value is highly detrimentally affected.

The flame-retardant methacrylic composition is opaque, which makes it possible to obtain a good surface state, a good resistance to scratching and a good resistance to UV radiation. It is therefore not necessary to use a protective paint, as is the case, for example, for flame-retardant mixtures of polycarbonate and of ABS. Preferably, the composition is devoid of halogenated flame-retardant compound, in particular brominated flame-retardant compound.

The UL-94 test is a test widely used in the field of the flame retardancy of polymeric materials. It makes it possible to evaluate the ability of a material which has been ignited to extinguish the flame. The test makes it possible to assign a rating according to the rate of burning, the time necessary for the flame to extinguish, the fact that there are or are not burning drips, and the like. The rating according to the UL-94 test is always accompanied by the thickness of the sample. The ratings of the UL-94 test are as follows:
HB: slow burning with a horizontal sample and burning rate <76 mm/min for a thickness <3 mm.
V-1: the burning stops after 30 seconds for a vertical sample, no flaming drips.
V-0: the burning stops after 10 seconds for a vertical sample, no drips.

The flame-retardant methacrylic composition is obtained by compounding, in the molten state, the methacrylic polymer, at least one flame-retardant agent of formula (I) or (II) and optionally at least one other flame-retardant compound. This operation is carried out in any device for mixing thermoplastic polymers known to a person skilled in the art. It is, for example, a kneader or an extruder, for example a twin-screw extruder.

The methacrylic composition can comprise one or more other additives which perform other roles. They can be an organic dye or inorganic pigment which is coloured, a plasticizer, a UV inhibitor, a light or heat stabilizer, an antioxidant, a light-scattering filler or a filler which introduces mattness.

The methacrylic composition can also comprise one or more other compatible or incompatible thermoplastic polymers, so as to reinforce certain properties. For example, polycarbonate (PC) or an impact modifier, the role of which is to improve the impact strength, may be involved. For example, an impact modifier in the form of multilayer particles of core-shell type may be involved. For example, an impact modifier in the form of multilayer particles of core-stell type may be involved.

Use of the Flame-retardant Methacrylic Composition

The composition according to the invention can be converted with the usual techniques for converting thermoplastics. It can be extruded, injection-moulded or moulded. It can, for example, be converted in order to obtain casings for televisions, covers and casings for electrical or electronic appliances, profiles or thermoformable sheets.

It can also be applied over a thermoplastic polymer (for example by coextrusion), so as to obtain a flame-retardant coating which improves these resistance to scratching and to UV radiation. In the case where the thermoplastic polymer exhibits good fire resistance, the flame-retardant coating improves these properties but without, however, damaging the fire resistance (see Examples 5-8), whether the latter is intrinsic to the thermoplastic polymer or obtained using a flame-retardant formulation. Hot pressing of the layers is a technique which can be used to apply the coating. Use may also be made of a coinjection-moulding or multiinjection-moulding technique. The multiinjection-moulding technique consists in injection moulding, in the same mould, the melts constituting each of the layers. According to a 1st multiinjection-moulding technique, the melts are injection moulded in the mould at the same time. According to a 2nd technique, a movable insert is situated in the mould. A melt is injection moulded in the mould by this insert and then the movable insert is shifted in order to injection mould another melt.

The preferred technique is coextrusion, which is based on the use of as many extruders as there are layers to be extruded (for further details, reference may be made to the work Principles of Polymer Processing by Z. Tadmor, published by Wiley, 1979).

This technique is more flexible than the above techniques and makes it possible to obtain multilayer structures even for complicated geometries, for example profiles. It also makes it possible to have excellent mechanical homogeneity. The coextrusion technique is a known technique in the conversion of thermoplastics (see, for example: Précis de matiéres plastiques, Structures-propriétés, 1989, mise en oeuvre et normalisation [Plastics handbook, structures-properties, 1989, use and standardization], 4th edition, Nathan, p. 126). The documents EP 1 174 465, U.S. Pat. No. 5,318,737, WO 00/08098 or GB 2 071 007 A1 disclose the coextrusion process with a thermoplastic polymer (capstock process). The capstock process consists in extruding the plastics in the form of sheets, in collecting these sheets together face against face and in then allowing the multilayer structure obtained to solidify.

The invention also relates to a process which consists in superimposing, in order, by coextrusion, in particular by the capstock process, by hot pressing or by multiinjection-moulding:
a layer (I) comprising the flame-retardant methacrylic composition,
a layer (II) comprising the thermoplastic polymer.

It is optionally possible to position an intermediate layer between the layers (I) and (II) (that is to say that there is present, in order, positioned one against the other: layer (I)/intermediate layer/layer (II)). The role of this intermediate layer can, for example, be to provide adhesion between the two layers (I) and (II). An example of an intermediate layer providing adhesion between the layers is given, for example, in WO 2006/053984.

The invention also relates to a multilayer structure comprising:

a layer (I) comprising the flame-retardant methacrylic composition,

a layer (II) comprising the thermoplastic polymer, and a possible intermediate layer positioned between the layers (I) and (II).

The thickness of the layer (I) is generally smaller than that of the layer (II) and varies from 10 to 700 μm.

### EXAMPLES

The following products were used:
Altuglas® V920 T: PMMA sold by Altuglas Int.
Altuglas® DR 2T: impact-resistant PMMA (rendered impact resistant using multilayer particles) sold by Altuglas Int.
Exolit® OP-930: flame-retardant agent sold by Clariant. It is a powder having a mean diameter D₅₀ (Microtrac) of approximately 3 μm (density: 1.35 g/cm³, phosphorus content: 23% by weight).
Exolit® OP-1230: flame-retardant agent sold by Clariant. It is a powder having a mean diameter D₅₀ (Microtrac) of between 20 and 40 μm approximately.

### Example 1 (according to the invention)

The methacrylic composition is obtained by blending V920 T (80% by weight) and Exolit® OP-930 (20% by weight) using a twin-screw extruder at a flow rate of 5 kg/h. The Exolit® OP-930 disperses well in the resin. Identical results are obtained with OP-1230.

### Example 2 (comparative)

This example is carried out with V920 T alone without flame-retardant agent.

### Example 3 (according to the invention)

The conditions of Example 1 are repeated with DR 2T and OP-1230.

### Example 4 (comparative)

This example is carried out with DR 2T alone without flame-retardant agent.

TABLE I

| | MFI, g/10 min | | |
|---|---|---|---|
| | (230° C., 3.8 kg) | Vicat (50° C.) | Rating |
| | according to ISO | according to | according to |
| Ex. | 1133 | ISO 306 | UL-94 |
| 1 (inv.) | 4 | 104 | V1, 3.2 mm |
| 2 (comp.) | 5 | 103 | HB |
| 3 (inv.) | 1.0 | 86.3 | V1, 3.2 mm |
| 4 (comp.) | 1.3 | 82.8 | HB |

It is found that the two Exolit® products (OP-930 or OP-1230) make it possible to obtain very good flame retardancy while retaining the other characteristics, which are the melt flow and the thermomechanical strength (Vicat). Surprisingly, these two properties were not significantly modified after the compounding, whereas, with numerous halogen-free flame retardants, such as phosphate esters, for example, the Vicat value is highly detrimentally affected.

At this content of 20%, the Exolit was found to disperse well and good compatibility was found but it has been found that, at contents greater than 25%, the flame-retardant agent no longer disperses as well, which even has the effect of reducing its effectiveness.

### Examples 5-8

Coextrusion tests (by the capstock process) were carried out on ABS. Two extruders were used, the heads of which are connected to a feedblock, then to a sheet die and completion by passing through a calendering point with 3 vertical rolls. Two-layer PMMA (0.3 mm)/ABS (2.7 mm) strips are thus prepared. The ABS used is VO (UL-94) and does not comprise a halogenated derivative. These strips are subsequently cut up to produce samples for the fire characterizations.

TABLE II

| | | Vertical burning test |
|---|---|---|
| | ABS (2.7 mm)/methacrylic | according to the UL-94 |
| Ex. | composition (0.3 mm) | procedure |
| 5 (comp.) | DR 2T | drips; no classification |
| 6 (comp.) | 85% DR 2T + 15% OP-1230 | drips; no classification |
| 7 (inv.) | 80% DR 2T + 20% OP-1230 | no drips; behaviour |
| | | similar to ABS alone |
| 8 (comp.) | 70% DR 2T + 30% OP-1230 | difficulty in extruding |
| | | the methacrylic |
| | | composition |

It is found, in Example 7, that the strips exhibit a behaviour towards fire similar to that of ABS alone (not decomposed) while furthermore having an improved resistance to UV radiation and to scratching (improved by the PMMA layer).

What is claimed is:

1. A flame-retardant methacrylic composition comprising a methacrylic polymer comprising, per 100 parts of methacrylic polymer, from 15 to 25 parts, of at least one flame-retardant agent of formula (I) or (II): 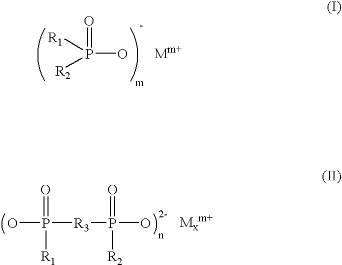
wherein:
R₁ and R₂ denote linear or branched C₁-C₆ alkyl groups and/or aryl groups;
R₃ denotes a linear or branched C₁-C₁₀ alkylene group, a C₆-C₁₀ arylene group, an alkylarylene group or an arylalkylene group;
M denotes Mg, Ca, Al, Sb, Sn, Ge, Ti, Zn, Fe, Zr, Ce, Bi, Sr, Mn, Li, Na or K;
m is an integer between 1 and 4;
n is an integer between 1 and 4;
x is an integer between 1 and 4.

2. The flame-retardant composition according to claim 1, wherein R₁ and R₂ are methyl, ethyl, n-propyl, isopropyl, n-butyl, tert-butyl, n-pentyl and/or phenyl groups.

3. The flame-retardant composition according to claim 1, wherein R₃ is the methylene, ethylene, n-propylene, isopropylene, n-butylene, tert-butylene, n-pentylene, n-octylene or n-dodecylene group. They can also be the phenylene, methylphenylene, ethylphenylene, tert-butylphenylene, methylnaphthylene, phenylethylene, phenylpropylene or naphthylene group.

4. The flame-retardant composition according to claim 1, wherein the flame-retardant agent is of formula (I) and M denotes Al, and R₁ and R₂ both denote a C₁-C₆ alkyl group.

5. The flame-retardant composition according to claim 4, wherein the flame-retardant agent has the formula (III) or (IV):

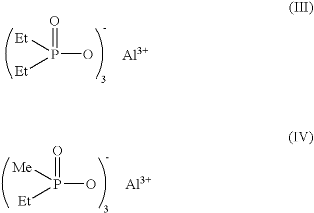

6. The flame-retardant composition according claim 1, wherein the flame-retardant agent is provided in the form of particles having a mean diameter D50 (Microtrac) of between 0.5 and 10 μm.

7. A process comprising superimposing, in order:
a layer (I) comprising the flame-retardant methacrylic composition as defined in any one of claims 1,
a layer (II) comprising a thermoplastic polymer, by coextrusion, by hotpressing or by multiinjection-moulding.

8. The process according to claim 7, wherein an intermediate layer is positioned between the layers (I) and (II).

9. The process according to claim 7, wherein the thermoplastic polymer is selected from the group consisting of a saturated polyester, ABS, a styrene/acrylonitrile copolymer, an acrylic/styrene/acrylonitrile (ASA) copolymer, a polystyrene, a polypropylene, a polyethylene, polycarbonate, PPO, a polysulphone, PVC, chlorinated PVC (CPVC), and expanded PVC.

10. A multilayer structure comprising:
a layer (I) comprising the flame-retardant methacrylic composition as defined in claim 1,
a layer (II) comprising a thermoplastic polymer, and an optional intermediate layer positioned between the layers (I) and (II).

11. Use of the flame retardant The flame-retardant composition according to claim 1 comprising casings for televisions, covers and casings for electrical or electronic appliances, profiles, or thermoformable sheets.

12. (canceled)

13. The flame-retardant composition according to claim 1 comprising a methacrylic polymer comprising, per 100 parts of methacrylic polymer, from 17 to 25 parts, of at least one flame-retardant agent of formula (I) or (II).

14. The flame-retardant composition according to claim 1 comprising a methacrylic polymer comprising, per 100 parts of methacrylic polymer, from 17 to 23 parts, of at least one flame-retardant agent of formula (I) or (II).

15. The flame-retardant composition according to claim 1 comprising a methacrylic polymer comprising, per 100 parts of methacrylic polymer, from 19 to 22 parts, of at least one flame-retardant agent of formula (I) or (II).

16. The flame-retardant composition according to claim 6 wherein the flame-retardant agent is provided in the form of particles having a mean diameter D50 (Microtrac) of between 1 and 5 μm.
